(19) United States
(12) Patent Application Publication
(10) Pub. No.: US 2012/0112707 A1
(43) Pub. Date: May 10, 2012

(54) POWER CONTROL MODULE FOR BATTERY PACK

(76) Inventor: Joseph S. Gottlieb, (US)

(21) Appl. No.: 12/941,780

(22) Filed: Nov. 8, 2010

(51) Int. Cl. H02J 7/06

(52) U.S. Cl. 320/163

(57) ABSTRACT

A battery management system is disclosed for control of individual cells in a battery pack. The battery management system includes a cell, a micro controller, a bleed off resistor, an analog circuit which includes a powered gate. In practice the powered gate which resides in the analog circuit is smartly configured such that in the event the micro controller becomes unresponsive while the bleed off resistor is connected to a cell the powered gate will open thereby disconnecting the bleed off resistor from the cell.

### TECHNICAL FIELD

The present invention relates generally to a method and apparatus for the management of individual cells in a battery system. More particularly, the present invention relates to the control of power when charging or discharging a battery pack such that over and under charging does not occur.

### BACKGROUND

Typically, battery systems, such as battery pack or strings, include a plurality of individual cells. A “cell” can mean a single electrochemical cell comprised of the most basic units, i.e. a positive plate, a negative plate, and an electrolyte. However, as used herein, the term is not so limited and may include a group of basic cells that can comprise single unit as a component of a battery string and the use of the latest in battery chemistries i.e. lithium and lithium combinations. A battery or battery string is a series or parallel connection of units or individual cells.

There is a tendency for each cell within individual batteries, when connected in series, to have different characteristics, such as energy storage capacity and discharge rates. These differences are caused be many variables including, but not limited to, temperature, initial tolerances, material impurities, porosity, electrolyte density, surface contamination, and age. A low-capacity cell will typically discharge more rapidly than the other cells. An overly discharged cell develops poor recharging characteristics and can be permanently damaged. A damaged cell will affect the operating characteristics of the entire battery pack. The damaged battery will have lower capacity and will become discharged more rapidly than a healthy battery. The failure of an individual cell can cause substantial damage to the battery system and accompanying equipment. Therefore, a need exists for a system to monitor individual or group of cells and to prevent overly charging and discharging of cells.

Various mechanisms have been developed to monitor and charge cells in a battery string. The classical means for controlling a battery is to balance the cells through equalization charging. This involves passing a low current through the battery pack thus charging the low cells while the fully charged cells become overcharged. It is done at a low current to minimize damage to the fully charged cells. However, balancing using this method is a slow process also and can damage certain battery chemistries.

The use of a battery management system to overcome over charging and discharging of the batteries is well known in the art. A battery management system monitors the charging and discharging of the batteries, by monitoring unit parameters such as voltage, discharge current, unit charge current acceptance characteristics, temperature and resistance of the batteries which is then recorded and analyzed by a microprocessor to determine the condition and state of each cell in the battery string. Although the use of battery management systems resolves many problems, a microprocessor within the battery management systems often causes problems. It is quite common for microprocessor's to become overloaded or unstable code condition sometimes know in the art as a software bug and leave the batteries in a vulnerable state either by overly discharging and charging of the batteries.

### SUMMARY

The deficiencies of the prior art are substantially overcome by the battery management system of the present invention which includes the use of a bleed off resistor to bleed off unwanted current to an individual cell enabling more power to the string and thereby producing quicker charge times. In a preferred embodiment of the present invention a pack of four cells can be placed in a battery pack with each pack having a battery management system or a plurality of battery packs having a battery management system. The battery management system includes a bleed off resistor for each cell. At full charge the voltage level of each cell is at 3.6 volts whereas a depleted cell would read 2.5 volts. In a string of cells one battery may charge quicker than the others. Under the present invention high current can be passed to the string to quickly charge each cell. In the event one cell in the string becomes charged sooner the battery management system is smartly configured utilizing the control of a microprocessor to connect the bleed off resistor to that charged cell thereby causing power to bleed off of that cell such that the cell is not overly charged and the total power to the string does not have to be reduces until all cells in the string are fully charged and read 3.6 volts. Furthermore in a preferred embodiment a field effect transistor or a powered gate is respectively placed such that the microprocessor can control the powered gate and the powered gate turns on and off the bleeding resister. The innovation of utilizing a powered gate to turn on and off the bleed resister is realized in the event the microprocessor becomes overloaded or unstable code condition sometimes know in the art as a software bug while the bleed off resistor is connected to a cell as the powered gate is smartly configured such that when the voltage of the cell becomes too low resulting from too much bleeding off from cell the powered gate is configured to turn off or disconnect the bleed off resister from the cell.

### BRIEF DESCRIPTION OF THE DRAWINGS

FIG. 1 is a block diagram representing prior art

FIG. 2 is a block diagram illustrating one embodiment of the invention

FIG. 3, represents a battery string

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

A portion may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, logic elements, look-up tables, or the like, which may carry out a variety of functions under the control of one or more microprocessors or other control devices. In addition, those skilled in the art will appreciate that the present invention may be practiced in conjunction with any number of batteries, battery management systems, controllers and that the system described herein is merely one exemplary application for the invention.

The overall purpose of the battery management system is to automatically manage each individual battery cell, one of a plurality of cells in a battery.

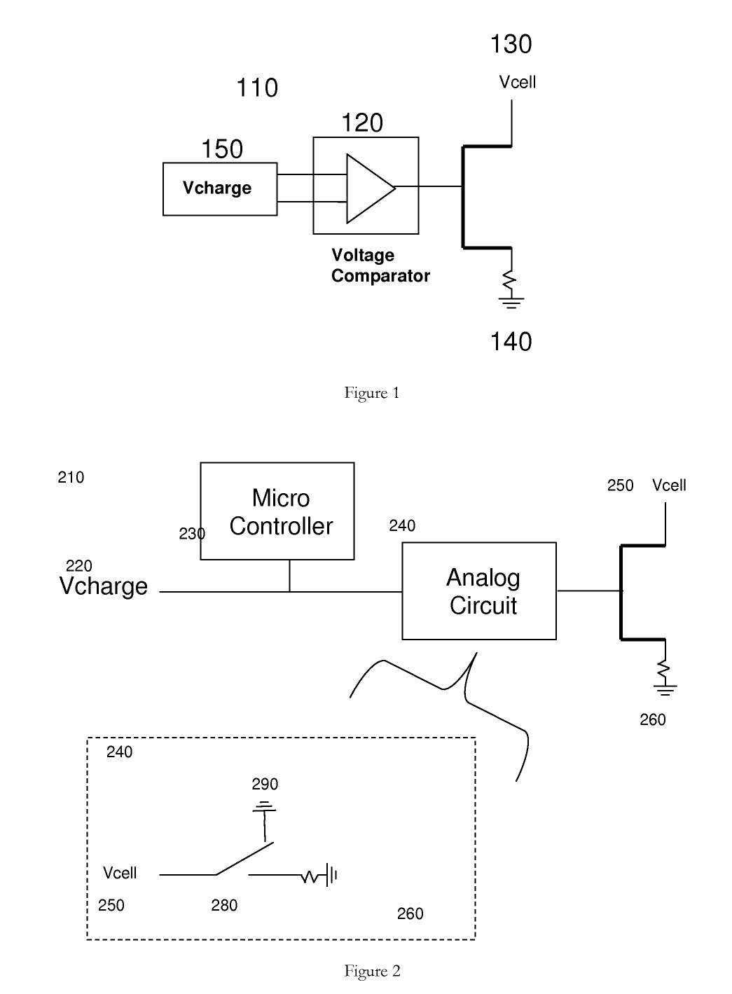

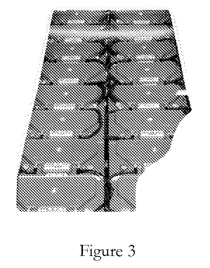

As represented in FIG. 1, the typical battery management systems (110) includes a battery or cells within a battery box (130), a voltage comparator (120), a bleed off resistor (140) and a charging voltage (150). In such traditional system in the event the voltage from the voltage cell (130) came to a level which represents full charge the voltage comparator (120) consistently compares the charging voltage (150) to the voltage of the cell (130) and in the event the voltage of the cell (130) is equal to or grater than the charging voltage (150) the shunt resister (140) is connected to the charging voltage (150) thereby bleeding off the charging voltage such that the battery cell is not overly charged.

FIG. 2, represents one embodiment of the present invention of a battery management system 210, whereby the charging voltage (220) is smartly connected to an analog circuit (240) and the analog circuit is smartly configured and connected to the cell (250) and the bleed off resistor (260) such that the analog circuit (240) is enabled to disconnect the bleed off resistor (260) in the event the cell voltage becomes too low. This is accomplished by including a powered gate (280) which is smartly configured to be powered by a predetermined voltage such that the powered gate will open when the predetermined voltage is not met. In practice, the micro controller (230) is smartly configured to connect and disconnect the bleed off resistor (260) by way of controlling the powered gate (280) to the cell (250) such that the bleed off resistor (160) can bleed off any charging voltage supplied to the cell (250). It can be common for the micro controller (230) to become unresponsive thereby leaving the bleed off resistor (260) connected to the cell (250) and thereby bleeding off too much power and possibly causing damage to the cell (250). In practice if the predetermined voltage of the powered gate (280) was 3.2 volts where a minimum of 3.2 volts is required to keep the powered gate closed thereby connecting the bleed off resistor (260) to the cell and any error in the system occurs for example the micro controller (230) became unresponsive thereby leaving the bleed off resistor connected to the cell (250) the powered gate (280) is smartly configured to disconnect the bleed off resistor (260) by opening the powered gate (280) when less than 3.2 volts is reached which will be a result when the bleed off resister (140) bleeds off too much power from the cell (130).

What is claimed is:

1. A battery management system for managing the charging of cells, the system comprising:
a bleed off resistor;
a micro controller for controlling; and
an analog circuit
wherein the analog circuit is smartly configured such that the bleed off resistor is disconnected when the cell voltage becomes too low.

2. A battery management system of claim 1, wherein an analog circuit comprises of a powered gate that has a predetermined voltage required to keep the powered gate closed.

3. A battery management system of claim 2, wherein the predetermined voltage required to keep the powered gate close is 3.2 volts.

4. A battery management system for managing the charging of cells, the system comprising:
a bleed off resistor;
a micro controller for controlling a bleed of resistor; and
an analog circuit
wherein the micro controller is analog circuit is smartly configured such that in the event the microprocessor becomes overloaded while the bleed off resistor is connected the bleed off resistor is disconnected when the cell voltage becomes too low.

5. A battery management system of claim 4, wherein an analog circuit comprises of a powered gate that has a predetermined voltage required to keep the powered gate closed.

6. A battery management system of claim 5, wherein the predetermined voltage required to keep the powered gate close is 3.2 volts.
